(19) United States
(12) Patent Application Publication
(10) Pub. No.: US 2024/0422707 A1
(43) Pub. Date: Dec. 19, 2024

(54) WIRELESS COMMUNICATOR METHOD REGARDING TIME SYNCHRONIZATION, APPARATUS, AND STORAGE MEDIUM

(71) Applicant: ZTE CORPORATION, Shenzhen (CN)

(72) Inventors: Zhuang LIU, Beijing (CN); Man ZHANG, Beijing (CN); Dapeng LI, Beijing (CN); Yin GAO, Beijing (CN)

(73) Assignee: ZTE CORPORATION, Shenzhen (CN)

(21) Appl. No.: 18/813,895

(22) Filed: Aug. 23, 2024

Related U.S. Application Data
(63) Continuation of application No. PCT/CN2022/141429, filed on Dec. 23, 2022.

(51) Int. Cl. H04W 56/00; H04W 24/02

(52) U.S. Cl. CPC H04W 56/0015; H04W 24/02

(57) ABSTRACT

A wireless communication method includes receiving, by a centralized unit control plane of a base station (gNB-CU-CP), information of one or more time source candidates from a first network node; determining, by the gNB-CU-CP, primary or suggested time source information of the first network node according to the one or more time source candidates; and transmitting, by the gNB-CU-CP, the primary or suggested time source information to the first network node.

### CROSS-REFERENCE TO RELATED APPLICATION

This application claims the benefit of priority under 35 U.S.C. § 120 as a continuation of International Patent Application No. PCT/CN2022/141429, filed on Dec. 23, 2022, the disclosure of which is incorporated herein by reference in its entirety.

### TECHNICAL FIELD

This disclosure is generally related to time synchronization, and more particularly to the time control among wireless communication networks.

### BACKGROUND

Wireless communication technologies are pivotal components of the increasingly interconnecting global communication networks. Wireless communications rely on accurately allocated time and frequency resources for transmitting and receiving wireless signals. Timing synchronization also serves as a basis for various application in the wireless communication system. Therefore, how to provide an accurate timing synchronization function may need to be considered.

### SUMMARY

This summary is a brief description of certain aspects of this disclosure. It is not intended to limit the scope of this disclosure.

According to one embodiment of this disclosure, wireless communication method is provided. The wireless communication method includes receiving, by a first central unit control plane of a base station (gNB-CU-CP), information of one or more time source candidates from a first network node; determining, by the first gNB-CU-CP, primary or suggested time source information of the first network node according to the one or more time source candidates; and transmitting, by the first gNB-CU-CP, the primary or suggested time source information to the first network node.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when executed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system, which can implement the methods and/or steps in this disclosure;

FIG. 2 shows an exemplary base station;

FIG. 3 shows an exemplary system structure of a base station system; and

FIGS. 4-8 show flow charts corresponding to embodiments of wireless communication methods of this disclosure.

### DETAILED DESCRIPTION

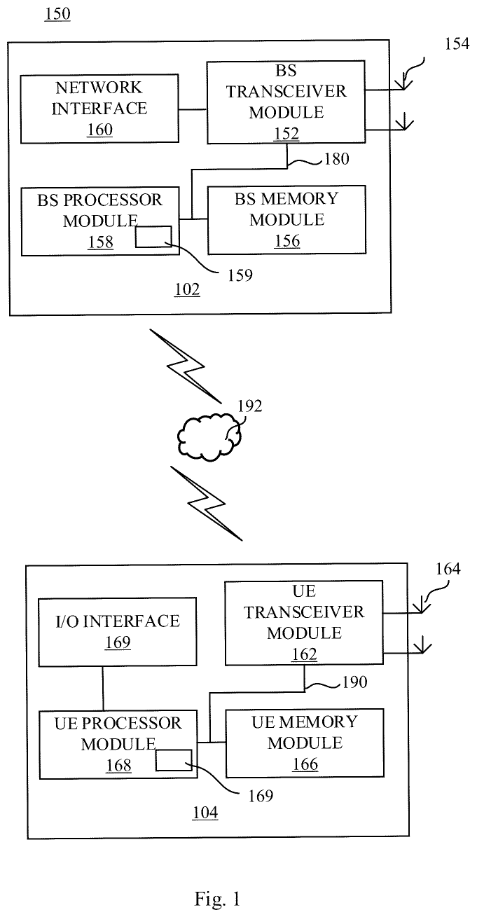

FIG. 1 illustrates a block diagram of an exemplary wireless communication system 150, in accordance with some embodiments of this disclosure. The system 150 may perform the various methods/steps disclosed in this disclosure. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, EEPROM memory, registers, ROM memory, EPROM memory, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

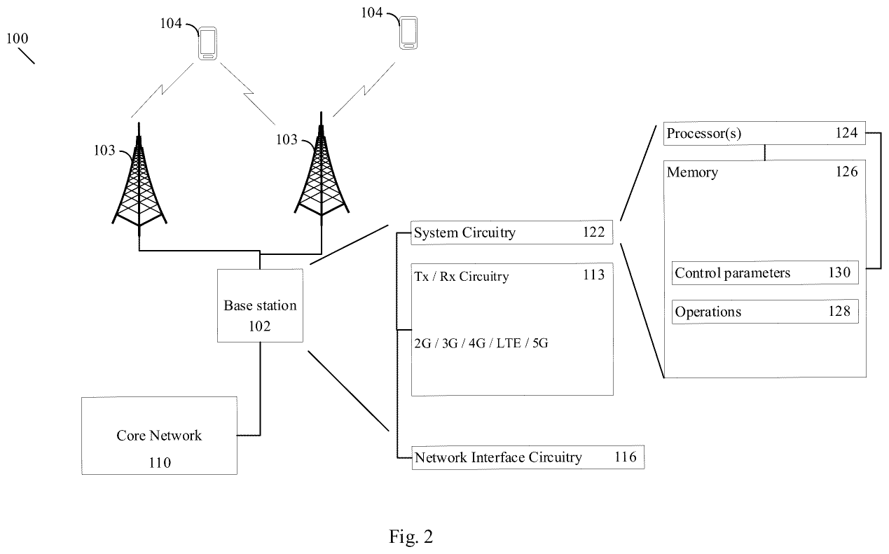

FIG. 2 shows an example base station 102. The example base station (e.g., a gNodeB (gNB)) may use one or more TRPs 103 and include radio Tx/Rx circuitry 113 to receive and transmit with UEs 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle DCI transmission to a UE. The control parameters 130 may include parameters or support execution of the operations 128. For example, control parameters may include network protocol settings, DCI format rules, bandwidth parameters, radio frequency mapping assignments, and/or other parameters.

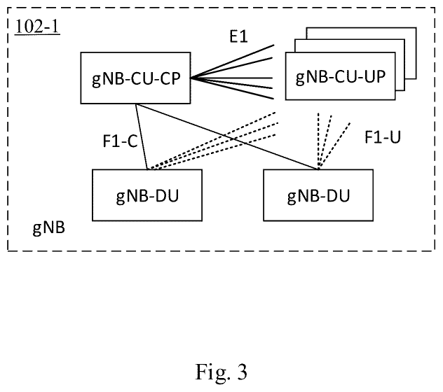

FIG. 3 shows an exemplary system structure of a base station system 102-1. The base station (or gNB) can include one gNB-CU (Centralized Unit) and one or more gNB-DU(s) (Distributed Unit). The gNB-CU can further include a control plane entity (gNB-CU-CP) and one or more user plane entities (gNB-CU-UP). For example, a gNB-CU-CP can be a logical network node that hosts the RRC (Radio Resource Control) and the control plane part of the PDCP protocol (Packet Data Convergence Protocol) of the gNB-CU for a gNB. A gNB-CU-UP can be a logical node that hosts the user plane part of the PDCP protocol of the gNB-CU for an en-gNB, and the user plane part of the PDCP protocol and the SDAP protocol of the gNB-CU for a gNB.

In general, a split gNB may include a gNB-CU-CP, one or more gNB-CU-UP(s), and one or more gNB-DU(s). A gNB-CU-CP and a gNB-CU-UP may be connected via an E1 interface. A gNB-DU may be connected to a gNB-CU-CP via an F1-C interface, and to a gNB-CU-UP via another F1-U interface. The gNB-DU and gNB-CU-UP may synchronize the time based on one or more local time sources by using one or more local time sources as a reference of time. However, the accuracy of the time source used by the gNB-DU or gNB-CU-UP may degrade; the time source may also fail. In this case, the gNB-DU or gNB-CU-UP may switch to a new time source from which the gNB-DU or gNB-CU-UP obtains the time information.

In one implementation, the NG-RAN (Next Generation Radio Access Network) may provide precise time information to UEs via the RRC (Radio Resource Control) signaling or via cell broadcasting. The precise time information (such as a reference time) sent to the UEs can be generated by the NG-RAN based on the time source(s) used in the NG-RAN, which usually obtains its clock information from, for example, the GNSS (Global Navigation Satellite System) receiver. The UEs may use the above received information to synchronize with the time in NG-RAN. However, the accuracy of original time source (i.e. time source 1) at the NG-RAN may degrade or fail. In this case, the NG-RAN may support Timing Resiliency. When the original time source (i.e. time source 1) fails or degrades, the NG-RAN may switch to a new time source (i.e. time source 2). Then, the NG-RAN may provide precise time information to UEs based on the switched new time source. The candidate time sources in the wireless communication system could be GNSS (Global Navigation Satellite System), gPTP (general precision time protocol), and IEEE Std 1588 (IEEE Standard for a Precision Clock Synchronization Protocol) etc.

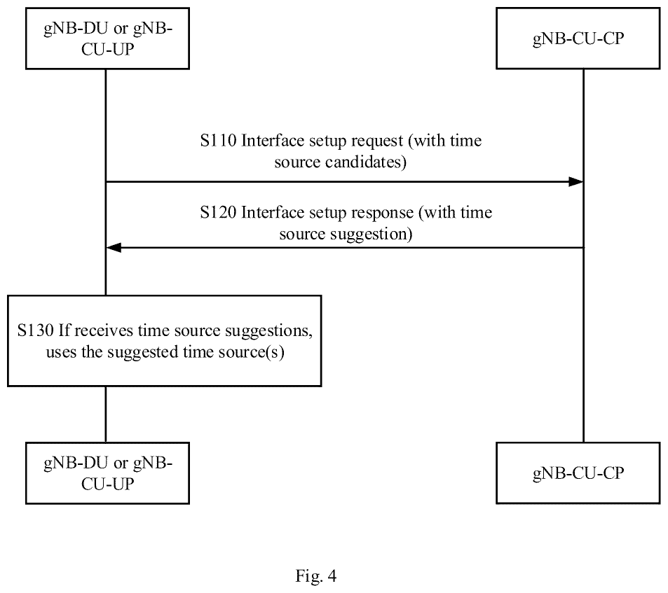

FIG. 4 shows a flow chart corresponding to one embodiment of this disclosure. In this embodiment, a gNB-DU or gNB-CU-UP may send a list of candidate time sources to the gNB-CU-CP. The gNB-CU-CP may determine one or more the primary or suggested time sources and transmit the corresponding information back to the gNB-DU or gNB-CU-UP. The gNB-DU or gNB-CU-UP can use the time source indicated by the gNB-CU-CP as a time reference for time synchronization.

S110: In this step, the gNB-DU or gNB-CU-UP may send an F1 or E1 SETUP REQUEST message to the gNB-CU-CP during an F1 or E1 interface setup procedure; the SETUP REQUEST message may indicate the supported time source(s) (or the candidate time sources). Alternatively or additionally, the gNB-DU or gNB-CU-UP may send a gNB-DU or gNB-CU-UP CONFIGURATION UPDATE message, during a configuration update procedure, to the gNB-CU-CP. The gNB-DU or gNB-CU-UP CONFIGURATION UPDATE message may similarly indicate the supported time source(s) (or the candidate time sources). The supported time source(s) may be organized as a supported time source list, indicating the time sources the gNB-CU-CP can choose from. The supported time source(s) may include a GNSS (Global Navigation Satellite System) time source, a gPTP (general precision time protocol) time source, and/or an IEEE 1588 time source etc.

S120: After the gNB-CU-CP receives the supported time source list from the sending node, the gNB-CU-CP may determine the primary or suggested time source(s) for the sending node according to the supported time source list to obtain primary or suggested time source information. Then, the gNB-CU-CP may send the corresponding response message (e.g, F1/E1 SETUP RESPONSE or GNB-DU/gNB-CU-UP CONFIGURATION UPDATE ACKNOWLEDGE) to the sending node, including the information of the primary or suggested time source(s) in the message.

Alternatively or additionally, the gNB-CU-CP also can send a gNB-CU/or gNB-CU-CP CONFIGURATION UPDATE ACKNOWLEDGE message to the gNB-DU or gNB-CU-UP, including the primary or suggested time source information in the message once the communication interface has been set up. Therefore, the time source used by the gNB-DU or gNB-CU-UP can be updated based on the command of the gNB-CU-CP after the initial set up stage.

Alternatively or additionally, the gNB-CU-CP may signal the same primary or suggested time source to different gNB-DUs and/or gNB-CU-UPs in order to coordinate the time synchronization of the different gNB-DUs and gNB-CU-UPs under the same gNB. In this example, the primary or suggested time source(s) of the gNB can be determined by the core network, such as a 5G core network. The determined time source can be transmitted to the gNB, such as the gNB-CU-CP, by the core network.

In one implementation, the primary time source can be used as the suggested time source indicates the time source of the highest priority. When the primary source is available or when it is recovered from a failure or degraded status, the gNB-DU or gNB-CU-UP may always use the primary time source first. On the other hand, the suggested time source can be a recommended time source for the first network node. The first network node may use the suggested time source, but not necessarily.

S130: After the gNB-DU or gNB-CU-UP receives the primary or suggested time source(s) from the gNB-CU-CP, the gNB-DU or gNB-CU-UP may use the primary or suggested time source for the time synchronization. For example, the gNB-DU or gNB-CU-UP may use the primary or suggested time source as a basis of the current time. The gNB-DU or gNB-CU-UP may also switch from another time source to the primary or suggested time source if the designated primary time source is available. Furthermore, if the time source indicated by the gNB-CU-CP is a primary time source, when the primary source becomes available or is recovered from a failure or degraded status, the gNB-DU or gNB-CU-UP may always uses the primary time source first.

In this embodiment, this disclosure provides a wireless communication method, including:
receiving, by a centralized unit control plane of a base station (gNB-CU-CP), information of one or more time source candidates from a first network node;
determining, by the gNB-CU-CP, primary or suggested time source information of the first network node according to the one or more time source candidates; and
transmitting, by the gNB-CU-CP, the primary or suggested time source information, indicating one or more primary or suggested time sources, to the first network node.

According to one implementation, the first network node is a distributed unit (gNB-DU) of the base station or a central unit user plane of a base station (gNB-CU-UP).

According to one implementation, the gNB-DU and the gNB-CU-UP can use the primary or suggested time source information for time synchronization. For example, the primary time source is designated as a preferred time source for the first network node. When the primary time source becomes available, the gNB-DU or the gNB-CU-UP can switch to the primary time source as indicated by the gNB-CU-UP.

According to one implementation, a time source corresponding to the time source information may include any one of GNSS time source, Generalized Precision Time Protocol time source (gPTP), or IEEE-1588 timing.

According to one implementation, the information of one or more time source candidates can be received in an interface setup request or a configuration update request and the primary or suggested time source information is transmitted in an interface set up response or configuration update acknowledgement.

According to one implementation, the primary or suggested time source information can be transmitted in an interface set up response or configuration update request.

According to one implementation, the primary time source can be a time source of a highest priority.

According to one implementation, determining the primary or suggested time source information of the first network node according to the one or more time source candidates includes selecting one or more primary or suggested time sources from the one or more time source candidates.

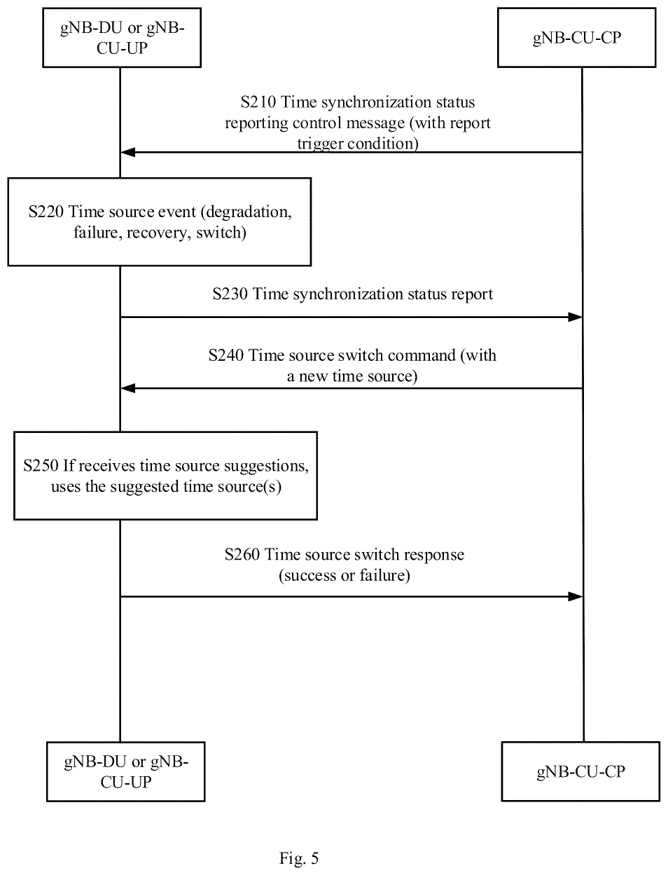

FIG. 5 shows a flow chart according to an embodiment of a wireless communication method of this disclosure. In this embodiment, the gNB-CU-CP can set up a time synchronization status report protocol with the gNB-DU or gNB-CU-UP. Once certain conditions is met, the gNB-DU or gNB-CU-UP can report the synchronization status to the gNB-CU-CP.

S210: In this step, the gNB-CU-CP may send a TIME SYNCHRONIZATION STATUS REPORTING CONTROL message to the gNB-DU or gNB-CU-UP to set up reporting of time synchronization status. This control message can indicate to the gNB-DU or gNB-CU-UP the event(s) that would trigger the gNB-DU or gNB-CU-UP to report a time synchronization status, such as a time synchronization status report. For example, the TIME SYNCHRONIZATION STATUS REPORTING CONTROL message may include the Time Synchronization Status (TSS) report trigger condition(s), which indicate the event(s) that would trigger the report of the time synchronization status. The condition, for example, can be that the current time source used by the gNB-DU or gNB-CU-UP degrades or fails; that the gNB-DU or gNB-CU-UP switches to a new time source; and/or that the time source of the gNB-DU or gNB-CU-UP is recovered from the primary time source.

S220: According to the condition(s) send up by the TIME SYNCHRONIZATION STATUS REPORTING CONTROL message, the gNB-DU or gNB-CU-UP can detect whether the pre-set time source event occurs.

S230: If the gNB-DU or gNB-CU-UP detects the corresponding event occurs according to the Time synchronization status (TSS) report trigger conditions, the gNB-DU or gNB-CU-UP would report time synchronization status to gNB-CU-CP by, for example, sending a TSS report to the gNB-CU-CP. Exemplarily, the TSS report may include at least one of the following:
Event type indication, indicating, for example, the event that triggers the current TSS report;
Current time source information, indicating, for example, the current time source used by the gNB-DU or gNB-CU-UP (e.g., a new time source successfully switched from the previous time source), and its type or quality;
Previous time source information, indicating, for example, the old/previous time source that was recently (but not currently) used by the gNB-DU or gNB-CU-UP, and its type or quality; and/or
New time source information, indicating, for example, the new time source that will be used by the gNB-DU or gNB-CU-UP, and its type or quality.

The current time source, for example, can be the current time source used by the gNB-DU or gNB-CU-UP; the previous time source, for example, can be the time source previously (but not currently) used by the gNB-DU or gNB-CU-UP; the new time source, for example, can indicate the new time source to be used by the gNB-DU or gNB-CU-UP.

With the steps above, the gNB-CU-CP can set up the protocol for the gNB-DU or gNB-CU-UP to report its TSS.

S240: Optionally, if the TSS report indicates that the time source of the gNB-DU or gNB-CU-UP failed or degraded, but without a new time source information included in the TSS report, the gNB-CU-CP can decide a new time source for the sending node. Then, the gNB-CU-CP may send a TIME SOURCE SWITCH COMMAND message to the gNB-DU or gNB-CU-UP. The TIME SOURCE SWITCH COMMAND message may include information of the new time source in the message. Additionally, the gNB-CU-CP can also forward the TSS report to the core network, and the new time source also can be determined by the core network. Then, the core network can transmit the new time source of the gNB to the gNB-DU, gNB-CU-UP, or gNB-CU-CP.

S250: Once the gNB-DU or gNB-CU-UP receives message indicating the new time source from the gNB-CU-CP, the gNB-DU or gNB-CU-UP may switch to the indicated new time source.

S260: The gNB-DU or gNB-CU-UP may sends the time source switch response message to the gNB-CU-CP. The response message may include the indication on whether the new time source is successfully adopted.

In this embodiment of this disclosure, the wireless communication method includes sending a first message to the first network node to request for a time synchronization status when at least one of the following conditions is met:
a current time source is degraded;
the current time source fails;
the current time source switches to a new time source; and
the current time source is recovered from the primary time source.

The wireless communication method may include sending a first message to the first network node to request for a time synchronization status, the time synchronization status including at least one of:
an event type indication; and
time source information.

According to one embodiment, the event type indication may indicate at least one of the following conditions that:
a current time source degrades or fails;
a current time source is switched to a new time source; and
a current time source is recovered from a primary time source.

According to one embodiment, the time source information includes at least one of current time source information, new time source information, or previous time source information.

According to one embodiment, the method may further include receiving a message from the first network node, the message including information on whether a time source of indicated by the primary or suggested time source information is adopted by the first network node.

According to one embodiment, the method may further include sending a time synchronization status reporting control message to configure transmission of a time synchronization status.

According to one embodiment, the method may further include sending the TSS report to a core network by the gNB-CU-CP.

According to one embodiment, the method may further include sending a time source switch command by the gNB-CU-CP. The time source switch command may indicate a new time source and can request the gNB-DU or gNB-CU-UP to switch its time source. The new time source can be determined by the gNB-CU-CP or by the core network.

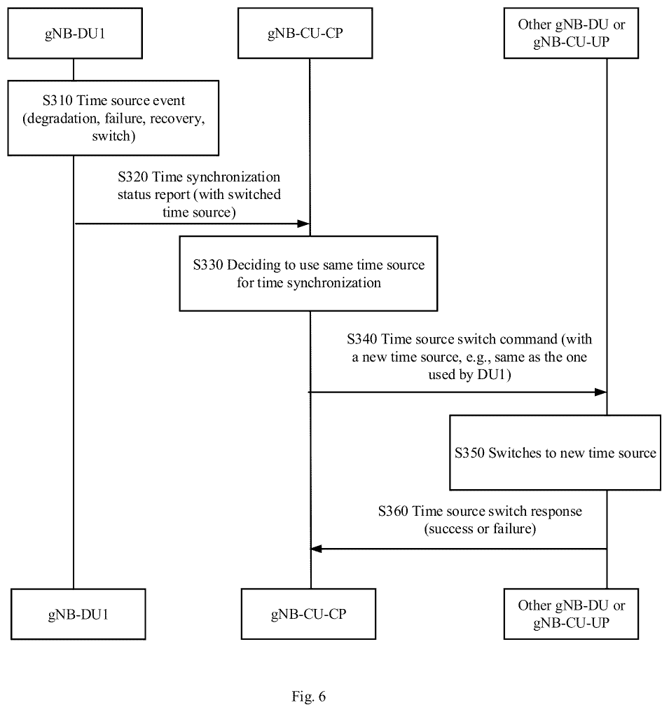

FIG. 6 shows a flow chart according to an embodiment of a wireless communication method of this disclosure. In this embodiment, the gNB-CU-CP can send a message with the time source information of the time source used by one gNB-DU1 to another gNB-DU or gNB-CU-UP, such that the another gNB-DU or gNB-CU-UP can use the same time source for time synchronization.

S310: The gNB-DU1 can determine to switch to the new time source (or trigger other time source events) in response to that the gNB-DU1 detects the time source fails or degrades.

S320: The gNB-DU1 may send a TSS report to the gNB-CU-CP in response to the time source event that triggered the report. The TSS report may include the new time source information of the new time source that has been adopted or to be adopted by the gNB-DU1, including, for example, the type of the new time source and the quality of the new time source. Exemplarily, the TSS report may include at least one of the following:
Event type indication, indicating, for example, the event that triggers the TSS report;
Current time source information, indicating, for example, the current time source used by the gNB-DU or gNB-CU-UP, and its type or quality;
Previous time source information, indicating, for example, the previous time source used by the gNB-DU or gNB-CU-UP, and its type or quality; and/or
New time source information, indicating, for example, the new time source used by the gNB-DU or gNB-CU-UP, and its type or quality.

S330: The gNB-CU-CP receives the new time source information of the gNB-DU1. The gNB-CU-CP may determine to use the same time source for different gNB-DUs and/or gNB-CU-UPs within the same gNB in order to coordinate the time synchronization of the different gNB-DUs and gNB-CU-UPs in the gNB.

S340: The gNB-CU-CP may send a TIME SOURCE SWITCH COMMAND message to one or more different gNB-DUs and/or gNB-CU-UPs. The TIME SOURCE SWITCH COMMAND message may indicate the same new time source in the message, such that the one or more different gNB-DUs and/or gNB-CU-UPs may use the same time source for time synchronization among the gNB.

S350: The gNB-DU and/or gNB-CU-UP receives the information of the new time source from the gNB-CU-CP. In response, the gNB-DU and/or gNB-CU-UP may switch to the indicated new time source.

S360: The gNB-DU and/or gNB-CU-UP may send the time source switch response message to the gNB-CU-CP. The time source switch response message may include the indication whether the new time source is successfully switched.

The disclosure of this embodiment provides a wireless communication method, including receiving new time information in a time synchronization status, indicating a new time source adopted by the first network node, from the first network node; and transmitting a message with the new time information to a second network node to synchronize the time of first network node and the second network node.

The wireless communication method may further include transmitting new time information to a second network node, in response to receiving a time synchronization status from a first network node, to request the second network node to report its time synchronization status.

In one embodiment, the method may further include receiving a switch response from a second network node to indicate whether the second network node has adopted the same time source commanded by the gNB-CU-CP.

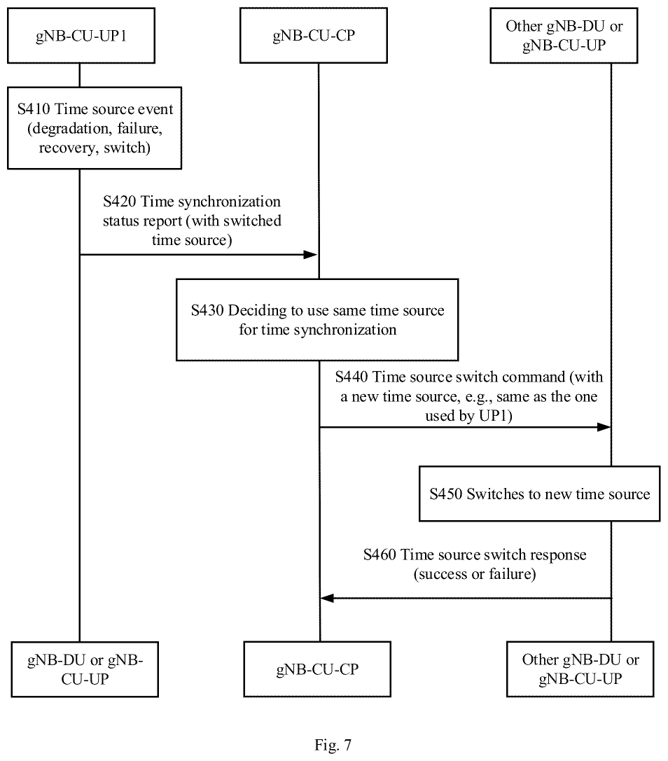

FIG. 7 shows a flow chart according to an embodiment of wireless communication method of this disclosure. In this embodiment, the gNB-CU-CP can send a message with the time source information of the time source used by one gNB-CU-UP1 to another gNB-DU or gNB-CU-UP, such that the another gNB-DU or gNB-CU-UP can use the same time source as the time reference for time synchronization.

S410: The gNB-CU-UP1 can decide to switch to the new time source (or trigger other time source events) in response to that the gNB-CU-UP1 detects the time source fails or degrades.

S420: The gNB-CU-UP1 may send a TSS report to the gNB-CU-CP in response to the time source event. The TSS report may include the new time source information of the new time source that has been adopted by the gNB-CU-UP1, including, for example, the type of the new time source and the quality of the new time source. Exemplarily, the TSS report may include at least one of the following:
Event type indication, indicating, for example, the event that triggers the TSS report;
Current time source information, indicating, for example, the current time source used by the gNB-DU or gNB-CU-UP, and its type or quality;
Previous time source information, indicating, for example, the previous time source used by the gNB-DU or gNB-CU-UP, and its type or quality; and/or
New time source information, indicating, for example, the new time source used by the gNB-DU or gNB-CU-UP, and its type or quality.

S430: The gNB-CU-CP receives the new time source information of the gNB-CU-UP1. The gNB-CU-CP may determine to use the same time source for different gNB-DUs and/or gNB-CU-UPs within the same gNB in order to coordinate the time synchronization of the different gNB-DUs and gNB-CU-UPs in the gNB.

S440: The gNB-CU-CP may send a TIME SOURCE SWITCH COMMAND message to one or more different gNB-DUs and/or gNB-CU-UPs. The TIME SOURCE SWITCH COMMAND message may include the same new time source in the message, such that the one or more different gNB-DUs and/or gNB-CU-UPs may use the same time source for time synchronization among the gNB.

S450: The gNB-DU and/or gNB-CU-UP receives the information of the new time source from the gNB-CU-CP. In response, the gNB-DU and/or gNB-CU-UP may switch to the indicated new time source.

S460: The gNB-DU and/or gNB-CU-UP may send the time source switch response message to the gNB-CU-CP. The time source switch response message may include the indication whether the new time source is successfully switched.

The disclosure of this embodiment provides a wireless communication method, including receiving new time information in a time synchronization status, indicating a new time source adopted by the first network node, from the first network node; and transmitting a message with the new time information to a second network node to synchronize the time of first network node and the second network node.

The wireless communication method may further include transmitting new time information to a second network node, in response to receiving a time synchronization status from a first network node, to request the second network node to report its time synchronization status.

In one embodiment, the method may further include receiving a switch response from a second network node to indicate whether the second network node has adopted the same time source commanded by the gNB-CU-CP.

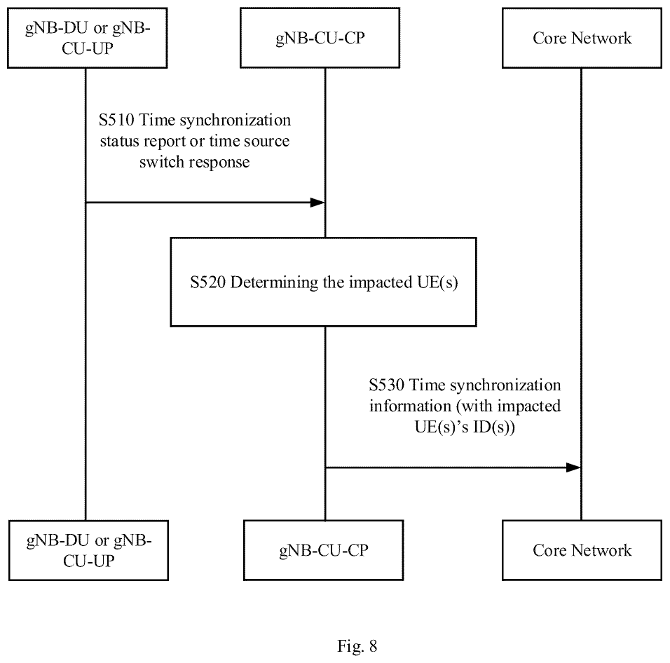

FIG. 8 shows a flow chart according to an embodiment of wireless communication method of this disclosure. In this embodiment, the gNB-CU-CP may report relevant time source information or time synchronization status information to the core network.

S510: If the gNB-DU or gNB-CU-UP detects the corresponding time source event occurs according to the TSS report trigger condition, the gNB-DU or gNB-CU-UP may send the TSS report to the gNB-CU-CP. Exemplarily, the TSS report may include at least one of the following:
Event type indication, indicating, for example, the event that triggers the TSS report;
Current time source information, indicating, for example, the current time source used by the gNB-DU or gNB-CU-UP, and its type or quality;
Previous time source information, indicating, for example, the previous time source used by the gNB-DU or gNB-CU-UP, and its type or quality; and/or
New time source information, indicating, for example, the new time source used by the gNB-DU or gNB-CU-UP, and its type or quality.

S520: The gNB-CU-CP may determine the impacted user reequipment(s) (UE(s)) based on the received TSS report from the gNB-DU or the gNB-CU-UP. For example, the gNB-CU-CP may determine the influenced UE(s) based on the UE(s) connected to the gNB-CU-UP, the UE(s) connected to the gNB-DU, the UE(s) connected to the cell, or the UE(s)'s location.

S530: The gNB-CU-CP may send the TSS information of the gNB to the core network. The TSS information may include the identity of the impacted UE(s).

According to the disclosure of this embodiment, the wireless communication method may further include receiving a time synchronization status and analyzing the time synchronization status to obtain an analysis result; and
sending the analysis result to a core network.

Exemplarily, the analysis result may include the information of influenced user equipment.

As shown in FIGS. 1-3 and the corresponding description, the wireless communication methods disclosed herein can be perform by one or more wireless communication apparatus. The wireless communication apparatus includes a memory storing one or more programs and one or more processors electrically coupled to the memory. The one or more processors are configured to execute the one or more programs to perform any step or method disclosed herein.

According to an aspect of this disclosure, a wireless communication device is provided, including:
a receiving module configured to receive, by a centralized unit control plane of a base station (gNB-CU-CP), information of one or more time source candidates from a first network node;
a determining module configured to determine, by the gNB-CU-CP, primary or suggested time source information of the first network node according to the one or more time source candidates; and
a transmitting module configured to transmit, by the gNB-CU-CP, the primary or suggested time source information, indicating one or more primary or suggested time sources, to the first network node.

According to one exemplary embodiment, the wireless communication device further includes a using module configured to use the primary or suggested time source information for time synchronization.

According to one exemplary embodiment, the transmitting module is further configured to transmit the same primary or suggested time source information of the first network node to a second network node to synchronize time of the first network node and the second network node.

According to one exemplary embodiment, the transmitting module is further configured to send a first message to the first network node to request the first network node to report a time synchronization status conditioned on any one of the following conditions:
a current time source degrades;
the current time source fails;
the current time source switches to a new time source; or
the current time source is recovered from the primary time source.

According to one exemplary embodiment, the transmitting module is further configured to send a first message to the first network node to request for a time synchronization status, the time synchronization status including at least one of: an event type indication; and time source information.

According to one exemplary embodiment, the receiving module is further configured to receive a time synchronization status, and an analyzing module is configured to analyze the time synchronization status to obtain an analysis result. The transmitting module is further configured to send the analysis result to a core network.

According to one exemplary embodiment, the transmitting module is further configured to send a time synchronization status reporting control message to configure transmission of a time synchronization status.

According to one exemplary embodiment, the receiving module is further configured to receive a message from the first network node, the message including information on whether a time source indicated by the primary or suggested time source information is adopted by the first network node.

According to one exemplary embodiment, the receiving module is further configured to receive new time information in a time synchronization status, indicating a new time source adopted by the first network node, from the first network node. The transmitting module is further configured to transmit a message with the new time information to a second network node to synchronize the time of first network node and the second network node.

According to one exemplary embodiment, the receiving module is further configured to receive a time synchronization status, indicating failure or degradation of current time source in the first network node, from a first network node; the transmitting module is further configured to transmit a message with new time information to the first network node to request to use a new time source; and the receiving module is further configured to receive response message including information on whether the new time source is successfully adopted by the first network node.

According to one exemplary embodiment, the determining module is configured to determine the primary or suggested time source information of the first network node according to the one or more time source candidates by selecting one or more primary or suggested time sources from the one or more time source candidates.

Certain aspects of this disclosure is enumerated as follows, but the description below are non-exhaustive aspects of some examples of this disclosure:

A wireless communication method, including receiving, by a first central unit control plane of a base station (gNB-CU-CP), information of one or more time source candidates from a first network node; determining, by the first gNB-CU-CP, primary or suggested time source information of the first network node according to the one or more time source candidates; and transmitting, by the first gNB-CU-CP, the primary or suggested time source information, indicating one or more primary or suggested time sources, to the first network node.

According to the disclosed wireless communication method(s), the first network node can be a distributed unit (gNB-DU) of the base station or a central unit user plane of a base station (gNB-CU-UP).

According to the disclosed wireless communication methods, the method may further include using the primary or suggested time source information for time synchronization.

According to the disclosed wireless communication methods, the primary time source can be designated as a preferred time source by the first network node for the first network node.

According to the disclosed wireless communication methods, the method may further include comprising transmitting the same primary or suggested time source information of the first network node to a second network node to synchronize time of the first network node and the second network node.

According to the disclosed wireless communication methods, the method may further include sending a first message to the first network node to request for a time synchronization status conditioned on any one of the following conditions:
a current time source degrades;
the current time source fails;
the current time source switches to a new time source; and
the current time source is recovered from the primary time source.

According to the disclosed wireless communication methods, the method may further include sending a first message to the first network node to request for a time synchronization status, the time synchronization status including at least one of:
an event type indication; and
time source information.

According to the disclosed wireless communication methods, the event type indication may indicate at least one of the following conditions that:
a current time source degrades or fails;
a current time source is switched to a new time source; and
a current time source is recovered from a primary time source.

According to the disclosed wireless communication methods, the time source information may include at least one of current time source information, new time source information, or previous time source information.

According to the disclosed wireless communication methods, a time source corresponding to the time source information may include any one of GNSS time source, Generalized Precision Time Protocol time source (gPTP), or IEEE-1588 timing.

According to the disclosed wireless communication methods, the method may further include receiving a time synchronization status and analyzing the time synchronization status to obtain an analysis result; and sending the analysis result to a core network.

According to the disclosed wireless communication methods, the analysis result may include identifier information of influenced user equipment.

According to the disclosed wireless communication methods, the method may further include sending a time synchronization status reporting control message to configure transmission of a time synchronization status.

According to the disclosed wireless communication methods, the time synchronization status can be a time synchronization status report.

According to the disclosed wireless communication methods, the method may further include receiving a message from the first network node, the message including information on whether a time source of indicated by the primary or suggested time source information is adopted by the first network node.

According to the disclosed wireless communication methods, the method may further include: receiving new time information in a time synchronization status, indicating a new time source adopted by the first network node, from the first network node; and transmitting message with the new time information to a second network node to synchronize the time of first network node and the second network node.

According to the disclosed wireless communication methods, the method may further include: receiving a time synchronization status, indicating failure or degradation of current time source in the first network node, from a first network node; transmitting a message with new time information to the first network node to request to use new time source; and receiving response message including information on whether the new time source is successfully adopted by the first network node.

According to the disclosed wireless communication methods, the second network node can be a distributed unit (gNB-DU) of the base station or a central unit user plane of a base station gNB-CU-UP.

According to the disclosed wireless communication methods, the information of one or more time source candidates can be received in an interface setup request or a configuration update request and the primary or suggested time source information is transmitted in an interface set up response or configuration update acknowledge.

According to the disclosed wireless communication methods, the primary or suggested time source information can be transmitted in an interface set up response or configuration update request.

According to the disclosed wireless communication methods, the primary time source can be a time source of a highest priority.

According to the disclosed wireless communication methods, determining the primary or suggested time source information of the first network node according to the one or more time source candidates may include selecting one or more primary or suggested time sources from the one or more time source candidates.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that comprises instructions executable with the processor or other processors to implement one or more of the features of the logical components. When any one of the logical components includes the portion of the memory that comprises instructions executable with the processor, the logical component may or may not include the processor. In some examples, each logical component may just be the portion of the memory or other physical memory that comprises instructions executable with the processor or other processor to implement the features of the corresponding logical component without the logical component including any other hardware. Because each logical component includes at least some hardware even when the included hardware comprises software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

What is claimed is:

1. A wireless communication method, comprising:
receiving, by a centralized unit control plane of a base station (gNB-CU-CP), information of one or more time source candidates from a first network node;
determining, by the gNB-CU-CP, primary or suggested time source information of the first network node according to the one or more time source candidates; and
transmitting, by the gNB-CU-CP, the primary or suggested time source information, indicating one or more primary or suggested time sources, to the first network node.

2. The wireless communication method of claim 1, wherein the first network node is a distributed unit (gNB-DU) of the base station or a centralized unit user plane of a base station (gNB-CU-UP).

3. The wireless communication method of claim 1, further comprising using the primary or suggested time source information for time synchronization.

4. The wireless communication method of claim 1, wherein the primary time source is designated as a preferred time source for the first network node.

5. The wireless communication method of claim 1, further comprising transmitting the same primary or suggested time source information of the first network node to a second network node to synchronize time of the first network node and the second network node.

6. The wireless communication method of claim 1, further comprising sending a first message to the first network node to request the first network node reporting a time synchronization status conditioned on any one of the following conditions:
a current time source degrades;
the current time source fails;
the current time source switches to a new time source; or
the current time source is recovered from the primary time source.

7. The wireless communication method of claim 1, further comprising sending a first message to the first network node to request for a time synchronization status, the time synchronization status including at least one of:
an event type indication; and
time source information;
wherein the event type indication indicates at least one of the following conditions that:
a current time source degrades or fails;
a current time source is switched to a new time source; or
a current time source is recovered from a primary time source;
wherein the time source information includes at least one of current time source information, new time source information, or previous time source information, and wherein a time source corresponding to the time source information includes any one of a GNSS (Global Navigation Satellite System) time source, a Generalized Precision Time Protocol time source (gPTP), or an IEEE-1588 timing.

8. The wireless communication method of claim 1, further comprising:
receiving a time synchronization status and analyzing the time synchronization status to obtain an analysis result; and
sending the analysis result to a core network;
wherein the analysis result includes identifier information of influenced user equipment.

9. The wireless communication method of claim 1, further comprising sending a time synchronization status reporting control message to configure transmission of a time synchronization status.

10. The wireless communication method of claim 6, wherein the time synchronization status is organized as a time synchronization status report.

11. The wireless communication method of claim 1, further comprising receiving a message from the first network node, the message including information on whether a time source indicated by the primary or suggested time source information is adopted by the first network node.

12. The wireless communication method of claim 1, further comprising:
receiving new time information in a time synchronization status, indicating a new time source adopted by the first network node, from the first network node; and
transmitting a message with the new time information to a second network node to synchronize the time of first network node and the second network node.

13. The wireless communication method of claim 1, further comprising:
receiving a time synchronization status, indicating failure or degradation of current time source in the first network node, from a first network node;
transmitting a message with new time information to the first network node to request to use a new time source; and
receiving response message including information on whether the new time source is successfully adopted by the first network node.

14. The wireless communication method of claim 5, wherein the second network node is a distributed unit (gNB-DU) of the base station or a centralized unit user plane of the base station gNB-CU-UP.

15. The wireless communication method of claim 1, wherein the information of one or more time source candidates is received in an interface setup request or a configuration update request and the primary or suggested time source information is transmitted in an interface set up response or configuration update acknowledgement.

16. The wireless communication method of claim 1, wherein the primary or suggested time source information is transmitted in an interface set up response or configuration update request.

17. The wireless communication method of claim 1, wherein the primary time sources are time sources of a highest priority.

18. The wireless communication method of claim 1, wherein determining the primary or suggested time source information of the first network node according to the one or more time source candidates includes selecting one or more primary or suggested time sources from the one or more time source candidates.

19. A wireless communication apparatus, comprising a memory storing one or more programs and one or more processors electrically coupled to the memory and configured to execute the one or more programs to perform the method of claim 1.

20. A non-transitory computer-readable storage medium, storing one or more programs, the one or more program being configured to, when executed by a processor, cause to perform the method of claim 1.
